(19) United States
(12) Patent Application Publication
(10) Pub. No.: US 2012/0066261 A1
(43) Pub. Date: Mar. 15, 2012

(54) CONTENT SEARCH APPARATUS, CONTENT SEARCH METHOD, CONTENT SEARCH PROGRAM, AND RECORDING MEDIUM

(75) Inventor: Tsuyoshi Saka, Kawagoe (JP)

(73) Assignee: PIONEER CORPORATION, Kanagawa (JP)

(21) Appl. No.: 13/319,432

(22) PCT Filed: May 12, 2009
(86) PCT No.: PCT/JP2009/058865

§ 371 Date: Nov. 8, 2011

(51) Int. Cl. G06F 17/30

(52) U.S. Cl. 707/780; 707/E17.014

(57) ABSTRACT

A content search apparatus that searches for content matching keywords, includes a history acquiring unit that acquires a user behavior history; a keyword acquiring unit that acquires keywords based on the user behavior history acquired by the history acquiring unit; a correlating unit that correlates with each of the keywords acquired by the keyword acquiring unit, attribute related information; a combining unit that among the keywords acquired by the keyword acquiring unit, combines the keywords that have been correlated with mutually different attribute related information by the correlating unit; and a searching unit that searches for content that matches the keywords combined by the combining unit. The correlating unit correlates with each of the keywords, attribute related information concerning plural attributes, and the combining unit combines the keywords whose correlated attribute related information overlap least.

### TECHNICAL FIELD

The present invention relates to a content search apparatus, content search method, content search program, and recording medium that retrieve content that is along the lines of user interest/preference and also unpredictable. However, use of the present invention is not limited to the content search apparatus, the content search method, the content search program, and the recording medium.

### BACKGROUND ART

Conventionally, information providing apparatuses have been proposed that, based on information concerning the preferences of users and the environment of use, generate an information search statement, use the generated search statement to perform an information search, and provide the search results to the user (for example, refer to Patent Document 1). When this information providing apparatus provides information to a group of people, the most suitable information is provided without ambiguity.

Further, an information search apparatus has been proposed that when searching for information, even among databases that are used at different frequencies by users, appropriately retrieves information meeting user preferences (for example, refer to Patent Document 2).

A system has been further proposed that in addition to user preference information, searches for information based on records of user behavior history (life log data) (for example, refer to Patent Document 3). Life log data is generated using various sensor devices (e.g., watch, global positioning system (GPS), bar code and two-dimensional code readers, digital camera, etc.) of a mobile telephone. Life log data is configured by content such as photographs and text (or information specifying content (uniform resource locator (URL)) and a profile identifying behavior of the user. A profile may include dates and times, behavior objectives, publication dates (release dates), etc.

Patent Document 1: Japanese Laid-Open Patent Publication No. 2006-127370

Patent Document 2: Published Japanese-Translation of PCT Application, National Publication No. 2005/066838

Patent Document 3: Japanese Laid-Open Patent Publication No. 2007-293768

### DISCLOSURE OF INVENTION

### Problem to be Solved by the Invention

However, with the technologies of Patent Documents 1 to 3, although content matching preference information and life log data of the user can be retrieved, searches concerning information that is not included in the preference information or the life log data of the user cannot be performed, arising in a problem that the range of user interest and preference is not expanded, and predictably, the same type of content is retrieved time after time and the user loses interest.

### Means for Solving Problem

To solve the problems above and achieve an object, a content search apparatus according to claim 1 is a content search apparatus that searches for content matching keywords and includes a history acquiring unit that acquires a user behavior history; a keyword acquiring unit that acquires keywords based on the user behavior history acquired by the history acquiring unit; a correlating unit that correlates with each of the keywords acquired by the keyword acquiring unit, attribute related information; a combining unit that among the keywords acquired by the keyword acquiring unit, combines the keywords that have been correlated with mutually different attribute related information by the correlating unit; and a searching unit that searches for content that matches the keywords combined by the combining unit.

Further a content search method according to claim 11 is a content search method of a content search apparatus that searches for content matching keywords. The content search method includes acquiring a user behavior history; acquiring keywords based on the acquired user behavior history; correlating with each of the acquired keywords, attribute related information; combining among the acquired keywords, the keywords that have been correlated with mutually different attribute related information; and searching for content that matches the combined keywords.

A content search program according to claim 12 causes a computer to execute the content search method according to claim 11.

A computer-readable recording medium according to claim 13 stores therein the content search program according to claim 12.

### BRIEF DESCRIPTION OF DRAWINGS

FIG. 1 is a block diagram of a functional configuration of a content search apparatus according to an embodiment;

FIG. 2 is a flowchart of a content search procedure of the content search apparatus;

FIG. 3 is a schematic of an overview of a content search system according to an example;

FIG. 4 is a block diagram of a hardware configuration of a navigation apparatus according to the example;

FIG. 5 is a flowchart detailing processes of the navigation apparatus;

FIG. 6 is a diagram of an example of life log data;

FIG. 7 is a diagram of an example of keyword related information;

FIG. 8 is a diagram of an example keyword combining;

FIG. 9 depicts an example of a display of keywords;

FIG. 10 depicts a display example of combined keywords;

FIG. 11 depicts a display example of the information related to content that matches the combined keywords; and

FIG. 12 depicts a display example of an added keyword.

### BEST MODE(S) FOR CARRYING OUT THE INVENTION

With reference to the accompanying drawings, preferred embodiments of a content search apparatus, a content search method, a content search program, and a recording medium according to the invention will be described.

### Embodiment

### Functional Configuration of Content Search Apparatus

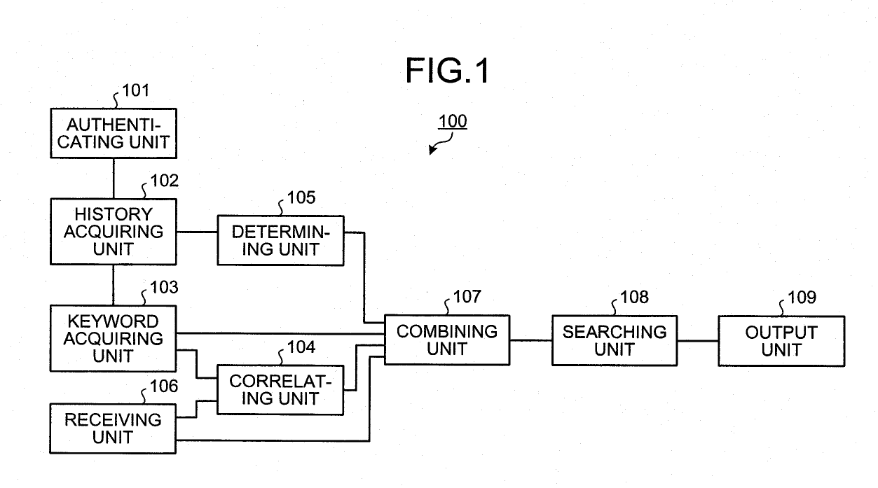

A functional configuration of a content search apparatus 100 according to an embodiment of the invention will be described. FIG. 1 is a block diagram of a functional configuration of a content search apparatus according to the embodiment.

As depicted in FIG. 1, the content search apparatus 100 includes an authenticating unit 101, a history acquiring unit 102, a keyword acquiring unit 103, a correlating unit 104, a determining unit 105, a receiving unit 106, a combining unit 107, a searching unit 108, and an output unit 109. The content search apparatus 100 searches for content that matches keywords. The content search apparatus 100 searches the content of a residential content server of the user and/or an external server via a network. A residential content server is, for example, a device capable of storing content, such as a television device, an audio device, a personal computer, etc. of the user. An external content server is a server provided on a network.

The authenticating unit 101 authenticates the user. The authenticating unit 101, for example, determines whether the person indicated by a tag that stores a behavior history acquired by the history acquiring unit 102 described hereinafter is a permitted user. If the content search apparatus 100 determines that the person is a permitted user, the person is authenticated.

The history acquiring unit 102 acquires a behavior history. A behavior history is, for example, life log data and information indicating dates and times that a DVD, compact disk (CD), etc. was played, and the titles and release dates of the DVDs, CDs, etc. Behavior history may further include dates and times when television was watched or the internet browsed as well as information indicating content titles, etc. Behavior history may further include information indicating dates and times that purchases were made, the name and type of the product purchased, etc. The history acquiring unit 102 may acquire a behavior history for multiple users or may acquire a behavior history for only a user authenticated by the authenticating unit 101.

The keyword acquiring unit 103 acquires keywords, based on the user behavior history acquired by the history acquiring unit 102. A keyword is, for example, a word used when content is searched for. The keyword acquiring unit 103 may acquire keywords generated by the content search apparatus 100 or may acquire keywords generated by a keyword generating server, not depicted. The keyword acquiring unit 103 may acquire, as a new keyword, a search result obtained by the searching unit 108 described hereinafter.

The correlating unit 104 correlates the keywords acquired by the keyword acquiring unit 103 with information related to an attribute. Attribute related information is, for example, information related to the genre of content that has been played or listened to such as a movie or music or information related to a region. The correlating unit 104 may correlate the keyword with information related to multiple attributes. Furthermore, the correlating unit 104 may correlate the keyword with hierarchized information related to multiple attributes. In other words, when the correlating unit 104 correlates the keyword with information related to multiple attributes, the information related to multiple attributes may or may not include the convention of upper and lower levels. With the keywords, the correlating unit 104 may correlate attribute related information generated by the content search apparatus 100 and may correlate attribute related information generated together with keywords by a keyword generating server not depicted.

Based on the user behavior history acquired by the history acquiring unit 102, the determining unit 105 determines behavior trends of the user. A behavior trend is information indicative of characteristics of the user, such as for example, information indicating that the user is keen to trends, if the user views a DVD or CD within a given number of day from the release date, and information indicating that the user is inclined to shop, if a product is purchased.

The receiving unit 106 sequentially receives from the user, two or more keywords selected from among the keywords correlated with attribute related information by the correlating unit 104. The receiving unit 106, for example, after receiving a selected keyword, further receives another keyword selected from among keywords that are presented by the combining unit 107 and correlated with an attribute different from that correlated with the initially selected keyword. The initially selected keyword and the subsequently selected keyword may be keywords acquired based on behavior histories of different users or keywords acquired based on the behavior history of a single user.

The combining unit 107, among the keywords acquired by the keyword acquiring unit 103, combines keywords correlated with differing attribute information by the correlating unit 104. The combining unit 107 combines two or more keywords. The combining unit 107 may combine keywords that are of different users and correlated with information related to different attributes by the correlating unit 104. In other words, the combining unit 107 may combine keywords that are based on the behavior history of a single user or may combine keywords that are based on the behavior histories of different users.

For example, if a keyword has been correlated with information related to multiple attributes by the correlating unit 104, the combining unit 107 combines keywords whose correlated attribute information overlap least. Further, if information related to multiple attributes is hierarchized and correlated by the correlating unit 104, the combining unit 107 may combine keywords having mutually different attribute related information at each hierarchal level. If information related to multiple attributes is hierarchized and correlated by the correlating unit 104, the combining unit 107 may combine keywords whose attribute related information, which has been correlated for each hierarchal level, overlap least at higher hierarchal levels.

Further, the combining unit 107 may combine keywords for which the determining unit 105 has determined the user behavior trend to be identical and that have been correlated with attribute information that is mutually different, by the correlating unit 104. The combining unit 107 may cause the user to further select a keyword whose attribute related information correlated by the correlating unit 104, differs from that of the keyword already received from the user; and then combines the keyword further received by the receiving unit 106 and the keyword already received.

The searching unit 108 searches for content that matches the keywords combined by the combining unit 107. The searching unit 108 may search for content that matches a keyword that has not been combined by the combining unit 107. The searching unit 108, for example, searches the content of the residential content server of the user and of an external content server via a network.

The output unit 109 outputs search results obtained by the searching unit 108. Further, if an instruction to output content retrieved by the searching unit 108 is received from the user, the output unit 109, for example, may further output the content.

### Content Search Procedure of Content Search Apparatus

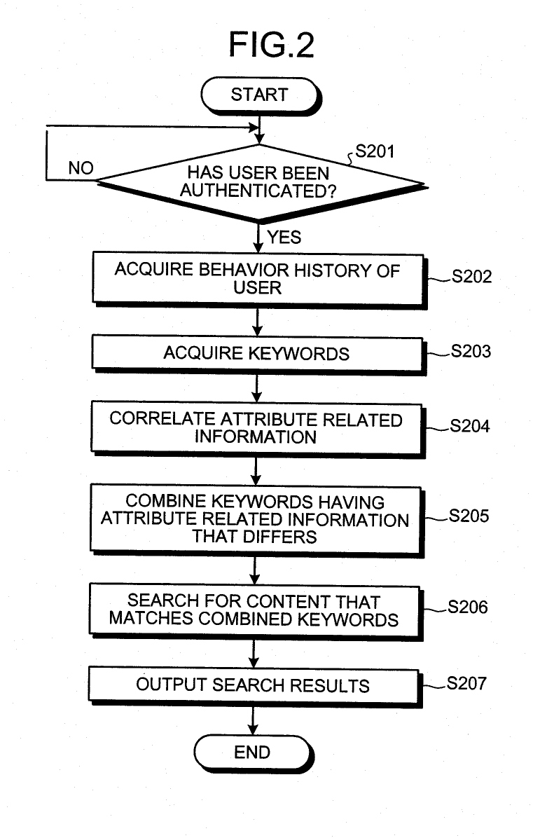

A content search procedure of the content search apparatus 100 will be described. FIG. 2 is a flowchart of a content search procedure of the content search apparatus. As depicted in the flowchart in FIG. 2, the content search apparatus 100 waits until the authenticating unit 101 authenticates a user (step S201: NO).

At step S201, when a user has been authenticated (step S201: YES), the history acquiring unit 102 acquires a behavior history of the user (step S202). The keyword acquiring unit 103 acquires keywords that are based on the behavior history acquired at step S202 (step S203). The correlating unit 104 correlates attribute related information with the keywords acquired at step S203 (step S204).

The combining unit 107, from among the keywords acquired at step S203, combines keywords having mutually different attribute related information correlated at step S204 (step S205). The searching unit 108 searches for content that matches the keywords combined at step S205 (step S206). The output unit 109 outputs the search results obtained at step S206 (step S207), ending a series of the processes.

In the flowchart depicted in FIG. 2, configuration may be such that at step S201, the content search apparatus 100 determines whether multiple users have been authenticated and when two or more users have been authenticated, the content search apparatus 100 proceeds to step S202. In this case, at step S205, keywords may be combined that are for different users and respectively have attribute information that differ.

Further, in the flowchart in FIG. 2, before step S205, the determining unit 105 may determine user behavior trends, based on the user behavior history acquired at step S202. In this case, at step S205, keywords that concern identical user trends and have attribute information that differ may be combined.

In the flowchart depicted in FIG. 2, at step S204, information related to multiple attributes may be correlated with the keywords. In this case, at step S205, keywords whose attribute related information overlap least may be combined.

Further, in the flowchart in FIG. 2, after search results are output at step S207, if an instruction to output the content retrieved at step S206 is received from the user, the content may be output.

As described, in the content search apparatus 100 according to the embodiment, the keyword acquiring unit 103 can acquire keywords that are based on the user behavior history acquired by the history acquiring unit 102 and the correlating unit 104 can correlate attribute related information to the keywords. Furthermore, the combining unit 107 can combine keywords that are correlated with information related to different attributes and the searching unit 108 can search for content that matches the combined keywords. The content search apparatus 100 can further combine among keywords in the life log data of the user, keywords whose attributes differ and then search for content using the combined keywords as new keywords.

Therefore, content that the user would not normally search for can be retrieved along the lines of user interests/preferences, whereby the retrieved content is not predictable and therefore, the user can discover new interests and expand the range of his/her interests/preferences. Further, since there are numerous combinations of keywords, unexpected content can always be watched/listened to, preventing the user from losing interest in watching/listening to content.

Further, the content search apparatus 100 according to the embodiment can acquire behavior histories for multiple users by the history acquiring unit 102; and by the combining unit 107, can combine keywords that are of different users and that respectively have attribute related information that differ. Consequently, since keywords that are based on the life log data of different users can be combined, content can be retrieved that normally would not be searched for by the users, but is along the lines of the interests/preferences of each user. As a result, the users can further expand the range of their interests/preferences.

The content search apparatus 100 according to the embodiment can limit the behavior histories acquired by the history acquiring unit 102 to those of users who have been authenticated by the authenticating unit 101. Consequently, devices of an authenticated user and capable of storing content such as a television device, an audio device, and a PC can be searched for content.

The content search apparatus 100 according to the embodiment can correlate information related to multiple attributes with keywords, by the correlating unit 104; and by the combining unit 107, can combine keywords whose correlated attribute related information overlap least. Consequently, since keywords are correlated with information related to multiple attributes, more unpredictable content can be retrieved, whereby the range of user interests/preferences can be expanded.

Further, the content search apparatus 100 according to the embodiment can hierarchize and correlate information related to multiple attributes with keywords, by the correlating unit 104; and by the combining unit 104, can combine keywords having attribute information that is mutually different at each hierarchal level. Consequently, keywords having attribute related information that is mutually different at each hierarchal level can be combined, whereby more unpredictable content can be retrieved.

The content search apparatus 100 according to the embodiment can prevent odd combinations of keywords. In other words, for example, if attribute related information at a lower hierarchal level includes “Europe” and “Asia”, which differ, and attribute related information at a higher hierarchal level includes “place”, which is the same, a combination of “Europe” and “Asia” can be prevented. Consequently, for example, combinations of keywords, such as “Europe” and “Asia” that make retrieval of content matching the keywords difficult can be prevented.

The content search apparatus 100 according to the embodiment can combine, by the combining unit 107, keywords whose attribute related information correlated for each hierarchal level by the correlating unit 104 overlap least at higher hierarchal levels. Consequently, combinations of keywords that make retrieval of content matching the keywords difficult can be prevented.

The content search apparatus 100 according to the embodiment can determine, by the determining unit 105, user behavior trends, based on user behavior histories acquired by the history acquiring unit 102. By the combining unit 107, the content search apparatus 100 can further combine keywords for which the determining unit 105 has determined that the user behavior trend is identical and to which attribute information that differs is correlated by the correlating unit 104. Consequently, according to user behavior trends, numerous combinations can be narrowed down, whereby the user can retrieve content that is more along the lines of the interests/preferences of the user and also unpredictable.

The content search apparatus 100 according to the embodiment can sequentially receive by the receiving unit 106, two or more keywords selected by the user, from among keywords to which the correlating unit 104 has correlated attribute related information. The content search apparatus 100 causes the user to select another keyword whose attribute related information correlated by the correlating unit 104 differs from that of the keyword initially received from the user; and by the combining unit 107, combines the other keyword received by the receiving unit 106 and the initially received keyword. Consequently, the content search apparatus 100 can cause the user to select a combination of keywords that have mutually different attribute related information. Consequently, the user can select from among numerous combinations of keywords, a combination of interest.

The content search apparatus 100 according to the embodiment can output by the output unit 109, search results obtained by the searching unit 108. Consequently, the user can be provided content that the user would not normally retrieve, enabling the range of user interests/preferences to be broadened.

The content search apparatus 100 can acquire as a new keyword and by the keyword acquiring unit 103, search results obtained by the searching unit 108. Consequently, the user can add keywords generated from life log data of the user, enabling the range of user interests/preferences to be further broadened.

### Example

An example of the present invention will be described. In the example, a case will be described where the content search apparatus according to the present invention is implemented by a navigation apparatus equipped on a mobile object such as vehicle (including 4-wheel vehicles and 2-wheeled vehicles).

### Overview of the Content Search System

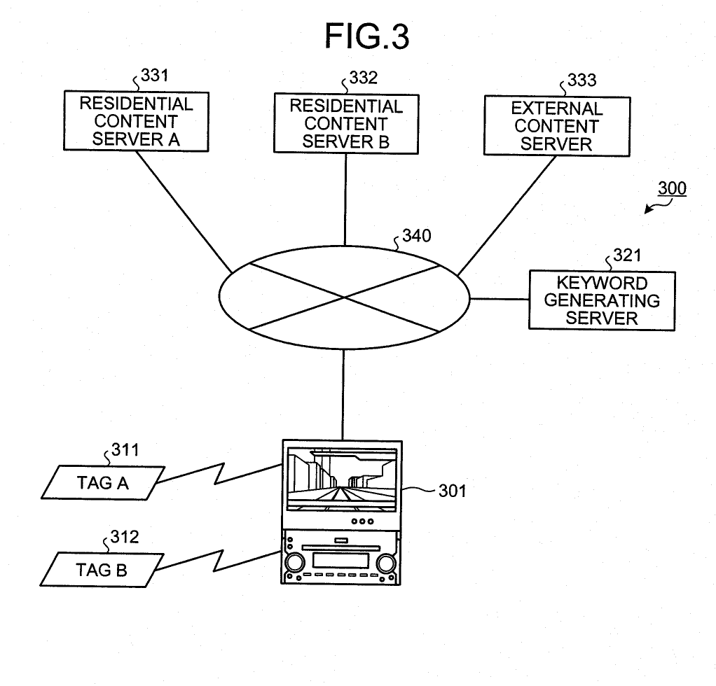

An overview of a content search system according to the example will be described. FIG. 3 is a schematic of an overview of the content search system according to the example. As depicted in FIG. 3, a content search system 300 includes a navigation apparatus 301, a tag A311, a tag B312, a keyword generating server 321, a residential content server A331, a residential content server B332, and an external content server 333.

The navigation apparatus 301, the tag A311, and the tag B312 are connected wirelessly or by wire. The navigation apparatus 301, the keyword generating server 321, the residential content server A331, the residential content server B332, and the external content server 333 are connected via a network 340. The tag A311 and the tag B312 may be connected via the navigation apparatus 301 and the network 340. Further, the keyword generating server 321 may be included in the navigation apparatus 301.

The tag A311 stores therein life log data of user A. The tag B312 stores therein life log data of user B. The residential content server A331 is a device of user A, capable of storing content, such as a television device, an audio device, a PC (personal computer). The residential content server B332 is a device of user B, capable of storing content, such as a television device, an audio device, a PC (personal computer).

The navigation apparatus 301 respectively acquires from the tag A311 and the tag B312, life log data of user A and user B, if the connected tag A311 and tag B312 are authenticated. The navigation apparatus 301 transmits the life log data to the keyword generating server 321, via the network 340, and receives generated keywords, which are correlated with attribute related information (hereinafter, “attribute information”).

From among keywords generated from the life log data of user A stored by the tag A311 and keywords generated from the life log data of user B stored by the tag B312, the navigation apparatus 301 combines keywords whose correlated attribute information overlap least. The navigation apparatus 301 searches the residential content server A331, the residential content server B332, and the external content server 333 for content that matches the combined keywords and outputs the search results. If the navigation apparatus 301 stores content, the navigation apparatus 301 may search the content for content that matches the combined keywords.

### Hardware Configuration of Navigation Apparatus

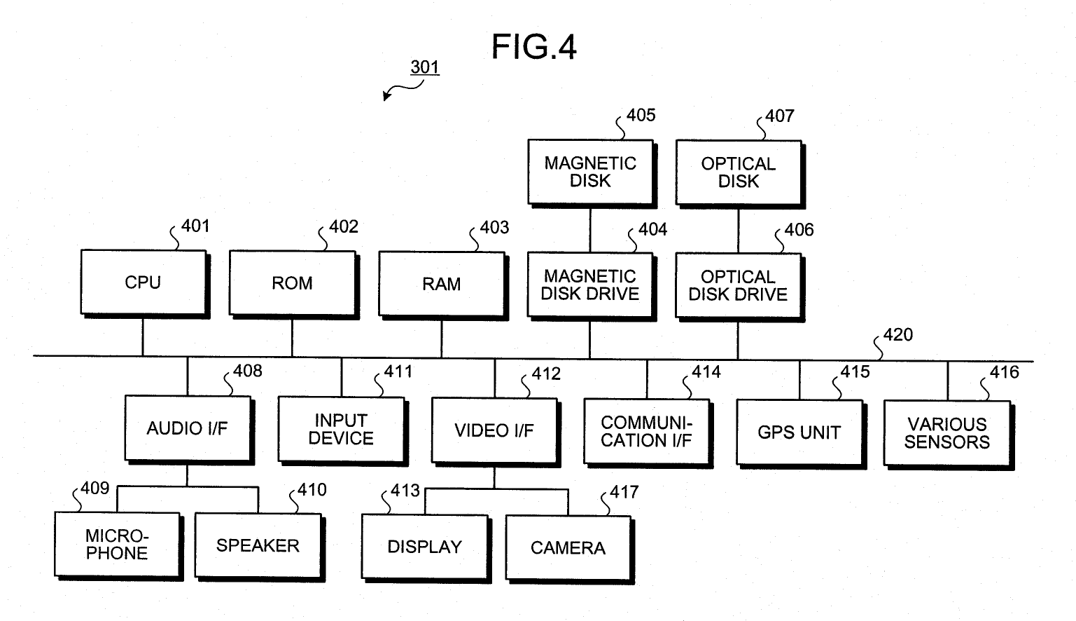

A hardware configuration of the navigation apparatus 301 according to the example will be described. FIG. 4 is a block diagram of a hardware configuration of the navigation apparatus according to the example. As depicted in FIG. 4, the navigation apparatus 301 includes a central processing unit (CPU) 401, ROM 402, a RAM 403, a magnetic disk drive 404, a magnetic disk 405, an optical disk drive 406, an optical disk 407, audio I/F (Interface) 408, a microphone 409, a speaker 410, an input device 411, a video I/F 412, a display 413, a communication I/F 414, a GPS unit 415, various sensors 416, and a camera 417. The components 401 to 417 are respectively connected by a bus 420.

The CPU 401 governs overall control of the navigation apparatus 301. The ROM 402 stores therein programs such as a boot program, a data updating program, an authentication program, a keyword combining program, and a content search program. The RAM 403 is used as a work area of the CPU 401. In other words, the CPU 401, while using the RAM 403 as a work area, executes various types of programs stored in the ROM 402 and thereby governs overall control of the navigation apparatus 301.

The authentication program causes authentication of the tag A311 and the tag B312. The authentication program further causes authentication of the life log data of user A and user B stored respectively in the tag A311 and the tag B312, and causes authorization of connection (via the network 340) of the residential content server A331 and the residential content server B332 respectively of user A and user B.

Although described in detail hereinafter, the keyword combining program causes keywords that have differing attribute information to be combined. For example, from among keywords A generated from the life log data of user A and keywords B generated from the life log data of user B, the keyword combining program causes combinations of keywords whose attribute information overlap least to be created. The keyword combining program further causes a first keyword selected from among the keywords A to be received and causes a second keyword whose correlated attribute information is different from that of the first keyword, to be selected from among the keywords B.

The content search program causes the residential content server A331, the residential content server B332, and the external content server 333, which have been authorized consequent to execution of the authentication program, to be searched for content that matches the keywords, which have been combined consequent to execution of the keyword combining program.

The magnetic disk drive 404, under the control of the CPU 401, controls the reading and writing of data with respect to the magnetic disk 405. The magnetic disk 405 stores therein data written under control of the magnetic disk drive 404. An HD (hard disk) or FD (flexible disk) may be used as the magnetic disk 405.

The optical disk drive 406, under the control of the CPU 401, controls the reading and writing of data with respect to the optical disk 407. The optical disk 407 is a removable recording medium that stores therein data that is readout under control of the optical disk drive 406. The optical disk 407 may further be a writable recording medium. In addition to the optical disk 407, an MO, a memory card, etc. may be used as a removable recording medium.

Examples of information stored on the magnetic disk 405 and the optical disk 407 include map information, functional data, and information related to keywords. Although described in detail hereinafter, keyword related information is, for example, keywords generated by the keyword generating server 321 and attribute information correlated with the keywords.

Although not depicted, the navigation apparatus 301 may include flash memory. Flash memory is non-volatile semiconductor memory that is rewriteable and removable. The CPU 401 controls the reading and writing of data with respect to flash memory. NAND-type flash memory and NOR-type flash memory may be used as flash memory. Examples of information stored by flash memory includes the above-mentioned keyword related information, map information, and functional data. Flash memory may further function as the ROM 402. In other words, flash memory may store the above-mentioned programs.

The audio I/F 408 is connected to the microphone 409, which is for audio input, and to the speaker 410, which is for audio output. Sound received by the microphone 409 is A/D converted at the audio I/F 408. The microphone 409 is, for example, disposed near a sun visor of the vehicle and may disposed singularly or in plural. Sound that, at the audio I/F 408, has been D/A converted from an audio signal is output from the speaker 410. Sound input from the microphone 409 can be recorded as audio data to the magnetic disk 405 or the optical disk 407.

The input device 411 may be, for example, a remote controller, a keyboard, or a touch panel having keys used to input characters, numerical values, or various kinds of instructions. Further, the input device 411 may be implemented by any one, or more, of the remote controller, the keyboard, and the touch panel.

The video I/F 412 is connected to the display 413. The video I/F 412 is made up of, for example, a graphic controller that controls the display 413, a buffer memory such as Video RAM (VRAM) that temporarily stores immediately displayable image information, and a control IC that controls the display 413 based on image data output from the graphic controller.

The display 413 displays icons, a cursor, menus, windows, or various data such as text and images. Map information may be drawn on the display 413 two-dimensionally or 3-dimensionally. A mark representing the current position of the vehicle on which the navigation apparatus 301 is equipped may be displayed superimposed on the map information displayed on the display 413. The current position of the mobile object is calculated by the CPU 401.

A CRT, a TFT liquid crystal display, a plasma display and so on may be employed as the display 313. The display 313 may be provided, for example, near the dashboard of the vehicle. The display 313 may be provided in plural on the vehicle, where in addition to a position near the dashboard, the display 313 may further be provided near the rear seat of the vehicle.

The communication I/F 414 is wirelessly connected to a network and functions as an interface between the navigation apparatus 301 and the CPU 401. Further, the communication I/F 414 is connected wirelessly to various communication networks, such as the Internet, and functions as an interface between the CPU 401 and the network.

The network includes a LAN, a WAN, a public line network, a mobile telephone network and so on. Specifically, the communication I/F 414 is made up of, for example, an FM tuner, a Vehicle Information and Communication System (VICS)/beacon receiver, a radio navigation apparatus, and other navigation apparatuses, and acquires road traffic information concerning congestion and traffic regulations distributed from a VICS center. VICS is a registered trademark. If Dedicated Short Range Communication (DSRC) is used, the communication I/F 414 is configured by an onboard wireless apparatus that performs bidirectional, wireless communication with a wireless apparatus provided along a road and acquires various types of information such as traffic information and map information. An example of DSRC is an electronic toll collection system (ETC).

The communication I/F 414 is connected to the tag A311 and the tag B312 wirelessly or by wire. The communication I/F 414 is further connected to the residential content server A331, the residential content server B332, and the external content server 333, via a network. The communication I/F 414 may be further connected to the keyword generating server 321, via the network 340.

The GPS unit 415 receives signals from GPS satellites and outputs information indicating the position of the vehicle. The information output by the GPS unit 415 is used together with values output from various sensors, described hereinafter, in the calculation of the current position of the vehicle, by the CPU 401. Information indicative of current position includes, for example, information indicating one point on map information, such as latitude, longitude, altitude, etc.

The various sensors 416 include a vehicular speed sensor, an acceleration sensor, and an angular speed sensor that respectively output information used to determine the position and behavior of the vehicle. Values output from the various sensors 416 are used by the CPU 401 to compute the current position and calculate changes in speed, direction, etc.

The camera 417 captures images inside and outside the vehicle. The images may be still images or moving images. For example, images taken by the camera 417 and capturing the behavior of passengers in the vehicle are output via the video I/F 412 to a recording medium such as the magnetic disk 405 and the optical disk 407. Further, images taken by the camera 417 and capturing a state outside the vehicle are output via the video I/F 412 to a recording medium such as the magnetic disk 405 and the optical disk 407. The camera 417 may have an infrared camera function and based on image information captured using the infrared camera function, distributions of surface temperatures of objects in the vehicle can be compared. Images output to the recording medium may be overwritten and stored.

The authenticating unit 101, the history acquiring unit 102, the keyword acquiring unit 103, the correlating unit 104, the determining unit 105, the receiving unit 106, the combining unit 107, the searching unit 108, and the output unit 109 of the content search apparatus 100 depicted in FIG. 1 are implemented by using programs and data stored to the ROM 402, the RAM 403, the magnetic disk 405, and the optical disk 407 of the navigation apparatus 301 depicted in FIG. 4 to execute a program on the CPU 401 and control the components of the navigation apparatus 301.

In other words, the navigation apparatus 301 according to the example executes the content search program stored to the ROM 402 as a recording medium in the navigation apparatus 301, whereby functions of the content search apparatus 100 depicted in FIG. 1 can be executed according to the content search procedure depicted in FIG. 2.

### Details of Navigation Apparatus Processes

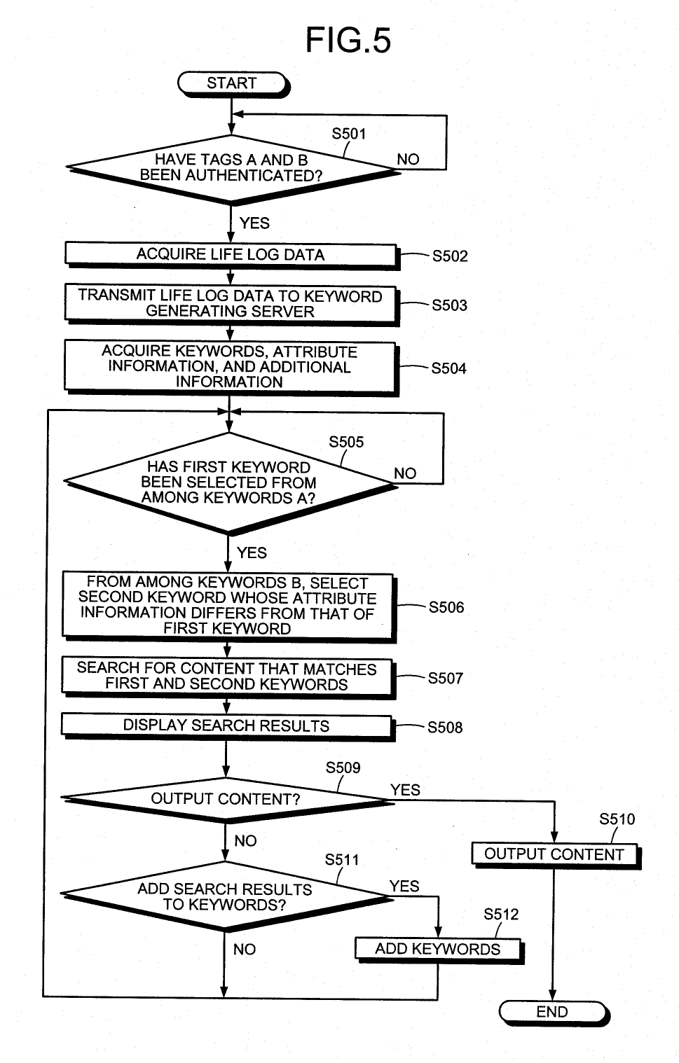

Details of processes by the navigation apparatus 301 will be described. FIG. 5 is a flowchart detailing processes of the navigation apparatus. As depicted in the flowchart in FIG. 5, the navigation apparatus 301 executes the authentication program and waits until the tag A311 and the tag B312 are authenticated (step S501: NO).

At step S501, when the tag A311 and the tag B312 have been authenticated (step S501: YES), the navigation apparatus 301 acquires the life log data of user A and of user B from the tag A311 and the tag B312, respectively (step S502).

The navigation apparatus 301 transmits to the keyword generating server 321, the life log data acquired at step S502 (step S503), and acquires keywords generated by the keyword generating server 321, together with attribute information and additional information (step S504). In other words, the navigation apparatus 301 acquires keywords A generated based on the life log data of user A and keywords B generated based on the life log data B of user B.

The navigation apparatus 301 waits until a first keyword is selected from among the keywords A (step S505: NO). At step S505, when a first keyword is selected (step S505: YES), the navigation apparatus 301 selects from among the keywords B, a second keyword whose correlated attribute information differs from that of the first keyword (step S506). The navigation apparatus 301 executes the content search program and searches the residential content server A331, the residential content server B332, and the external content server 333 for content that matches the first keyword selected at step S505 and the second keyword selected at step S506 (step S507).

The navigation apparatus 301 displays on the display 413, search results obtained at step S507 (step S508). The navigation apparatus 301 determines whether the content is to be output (step S509). At step S509, for example, the navigation apparatus 301 determines whether an output instruction has been received from the user. At step S509, if the navigation apparatus 301 determines that the content is to be output (step S509: YES), the navigation apparatus 301 outputs the content at the display 413 and/or from the speaker 410 (step S510), ending a series of the processes.

At step S509, if the navigation apparatus 301 determines that the content is not to be output (step S509: NO), the navigation apparatus 301 determines whether to add the search results displayed at step S508 to the keywords (step S511). At step S511, for example, the navigation apparatus 301 determines whether an instruction to add the search results to the keywords has been received from the user. At step S511, if the navigation apparatus 301 determines that the search results are to be added to the keywords (step S511: YES), the navigation apparatus 301 adds the search results to the keywords (step S512), returns to step S505, and repeats the processes therefrom.

On the other hand, at step S511, if the navigation apparatus 301 determines that the search results are not to be added to the keywords (step S511: NO), the navigation apparatus 301 returns to step S505, and repeats the processes therefrom.

In the flowchart depicted in FIG. 5, at step S504, after acquiring the keywords together with attribute information and additional information, the navigation apparatus 301 may display the keywords A and the keywords B on the display 413. At step S505, the navigation apparatus 301 may determine whether a first keyword has been selected from among the keywords A by the user. In this case, from among the keywords B, a keyword whose attribute information differs from that of the first keyword selected by the user may be acquired and displayed on the display 413. Further, configuration may be such that at step S506, the navigation apparatus 301 waits until a second keyword is selected by the user, from among displayed keywords and when selection of a second keyword is received, the navigation apparatus 301 proceeds to step S507.

Further in the flowchart in FIG. 5, at step S505, a first keyword may be randomly selected from among the keywords A. In this case, a second keyword whose attribute information differs from that of the first keyword may also be selected randomly from among the keywords B.

In the flowchart in FIG. 5, at step S506, from among the keywords B, a second keyword may be selected whose attribute information differs from that of the first keyword and whose additional information is identical to that of the first keyword.

### Example of Life Log Data

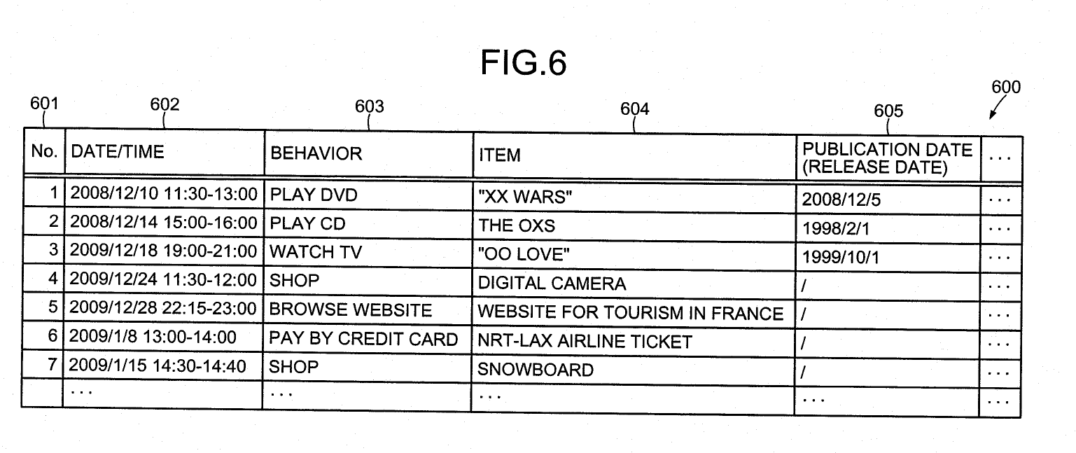

An example of life log data will be described. FIG. 6 is a diagram of an example of life log data. In FIG. 6, an example of life log data of user A will be described. As depicted in FIG. 6, life log data A600 includes, for example, a number (No.) 601, a date/time 602, a behavior 603, an item 604, and a publication date (release date) 605. A number 601 is a numeral that can identify a behavior history record and is assigned sequentially according to the date and time that the behavior occurred. A date/time 602 is the date and time that the behavior occurred and a behavior 603 details the behavior that occurred. An item 604 is a behavior objective and a publication date (release date) 605 is the publication date or release date of a movie, CD, book, etc. The life log data A600 may include, for example, an actor in a movie, incidental music, a music artist/performer, a compose/lyrist.

### Example of Keyword Related Information

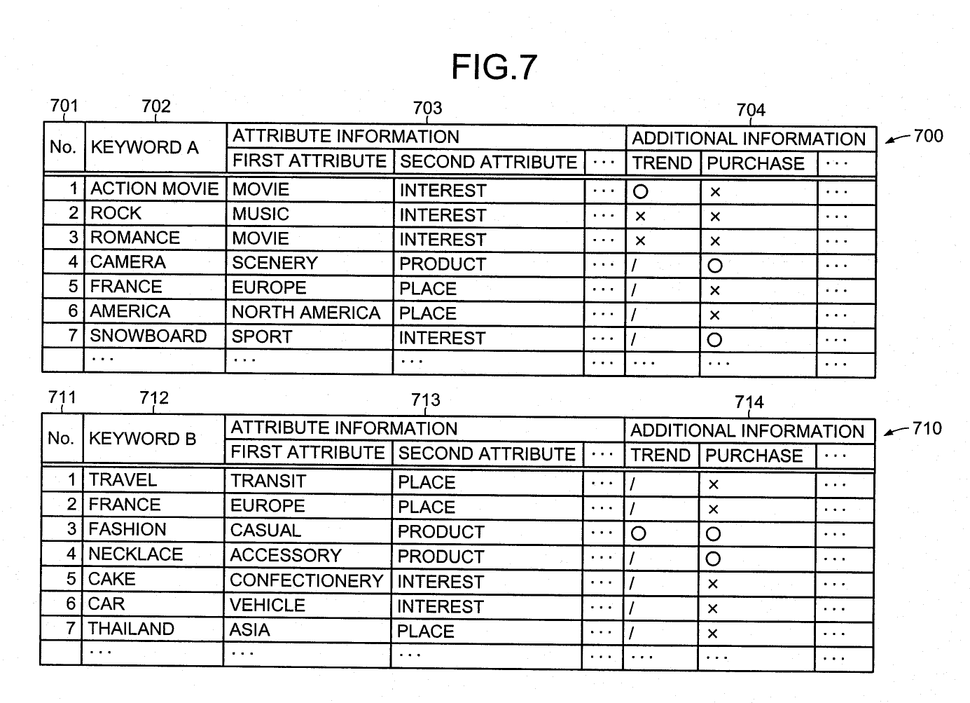

An example of keyword related information will be described. FIG. 7 is a diagram of an example of keyword related information. In FIG. 7, for example, information related to keywords A generated based on the life log data of user A and information related to keywords B generated based in the life log data of user B will be described. Information 700 related to keywords A correlates with each number 701 and keyword A702, attribute information 703 and additional information 704. The information 700 related to keywords A is generated based on the life log data A600 depicted in FIG. 6. For example, for information concerning life log data A whose number 601 is “1”, since the behavior 603 is “play DVD” and the item 604 is “XX Wars”, the keyword A702 for number 701 that is “1” is “action movie” and the attribute information 703 is “movie” and “interest”.

The attribute information 703 may include multiple entries, where for example, first attribute information is ranked lowest, and second attributed information and third attribute information are progressively ranked higher. If the publication date 605 and the date/time 602 in the life log data A600 depicted in FIG. 6 are within a given number of days of one another, the user is judged to be keen to trends and in the additional information 704 of the information 700 related to keywords A, a “o” may be entered in the trend field. If the behavior 603 in the life log data A600 depicted in FIG. 6 is “shopping”, the user is judged to be inclined to shop and in the additional information 704 of the information 700 related to keywords A, “o” may be entered in the purchase field. Information 710 related to keywords B, like the information 700 related to keywords A, is generated based on the life log data B of user B, which is not depicted.

### Example of Keyword Combining

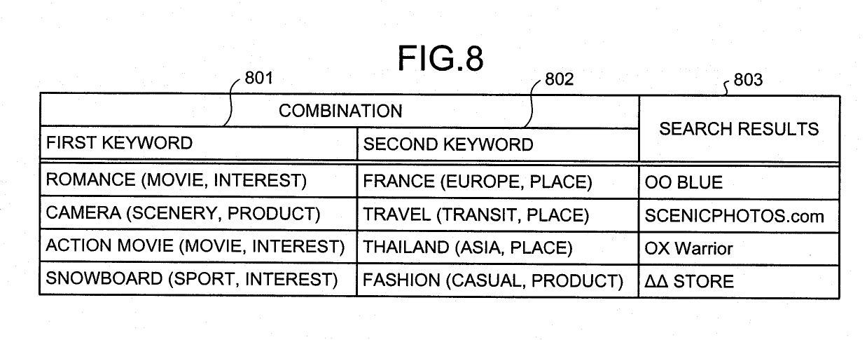

An example of keyword combining will be described. FIG. 8 is a diagram of an example keyword combining. In FIG. 8, an example will be described where keywords that have mutually different attribute information and that are generated based on the life log data of different users, are combined. As depicted in FIG. 8, first keywords 801 are keywords selected from among the keywords A702 depicted in FIG. 7 and second keywords 802 are keywords selected from among the keywords B712 depicted in FIG. 7. Search results 803 are the results obtained by searching for content that matches the combined first keyword 801 and second keyword 802.

In this example, it is assumed that “romance” is selected as the first keyword 801 and as depicted in FIG. 7, “romance” is correlated with “movie” and “interest” as attribute information 703. Therefore, as the second keyword 802, a keyword B712 is selected that does not have “movie” and “interest” correlated as attributed information 713 in the information 710 related to the keywords B depicted in FIG. 7. In this example, it is assumed that as the second keyword 802, “France”, for which the attribute information 713 is “Europe” and “place”, is selected and as the search result 803, the French romance “oo Blue” is retrieved.

In this manner, for example, a first keyword 801 and a second keyword 802 that have mutually different correlated attribute information are respectively selected from among the keywords A702 and the keywords B712. The first keyword 801 and the second keyword 802 may be selected from among keywords generated based on the life log data of the same user. In other words, the first keyword 801 and the second keyword 802 may be both selected from among the keywords A702 (or the keywords B712). Although in FIG. 8, two keywords are combined (a first keyword 801 and a second keyword 802), two or more keywords may be combined.

### Examples of Displayed Contents

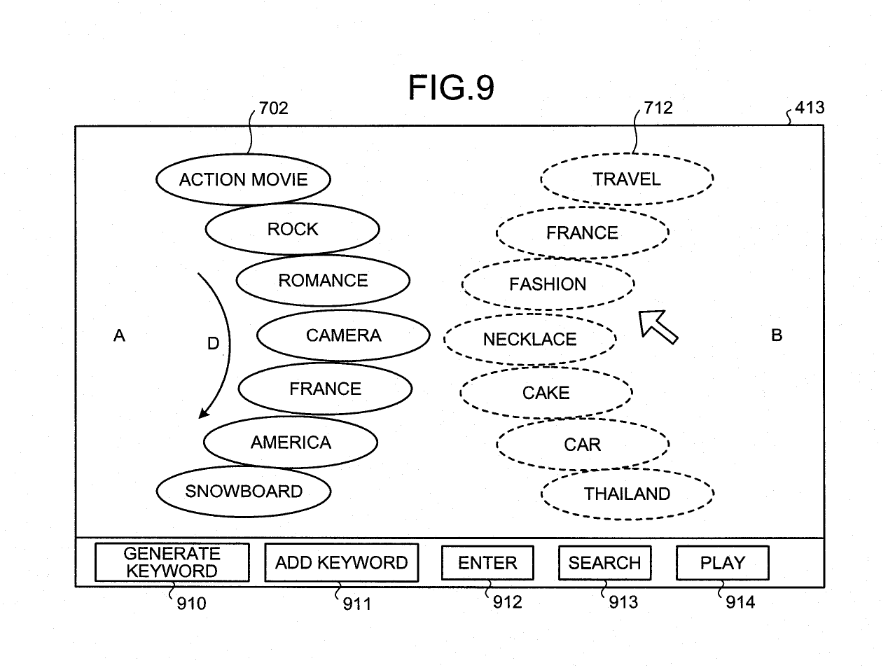

With reference to FIGS. 9 to 12, examples of contents displayed on the display 413 of the navigation apparatus 301 will be described. FIGS. 9 to 12 are diagrams of examples of displayed contents.

FIG. 9 depicts an example of a display of keywords. As depicted in FIG. 9, for example, after keywords together with attribute information and additional information are acquired at step S504 depicted in FIG. 5, the acquired keywords are displayed on the display 413. For example, the keywords A702 depicted in FIG. 7 are displayed on the left-half of the display 413 and the keywords B712 are displayed on the right-half of the display 413. Configuration may be such that consequent to a user operation with respect to a cursor or touch panel, the respective display positions of the keywords A702 move in a direction, for example, indicated by arrow D, whereby keywords A702 that were not displayed on the display 413 are displayed.

As depicted in FIG. 9, at the bottom of the display 413, buttons for receiving user instructions may be displayed. For example, a “generate keyword” button 910 for receiving an instruction to combine keywords, an “add keyword” button 911 for receiving an instruction to add search results to combined keywords as a new keyword, an “enter” button 912 for entering various instructions, a “search” button 913 for receiving an instruction to search for content that matches the keyword, and a “play” button 914 for receiving an instruction to play retrieved content.

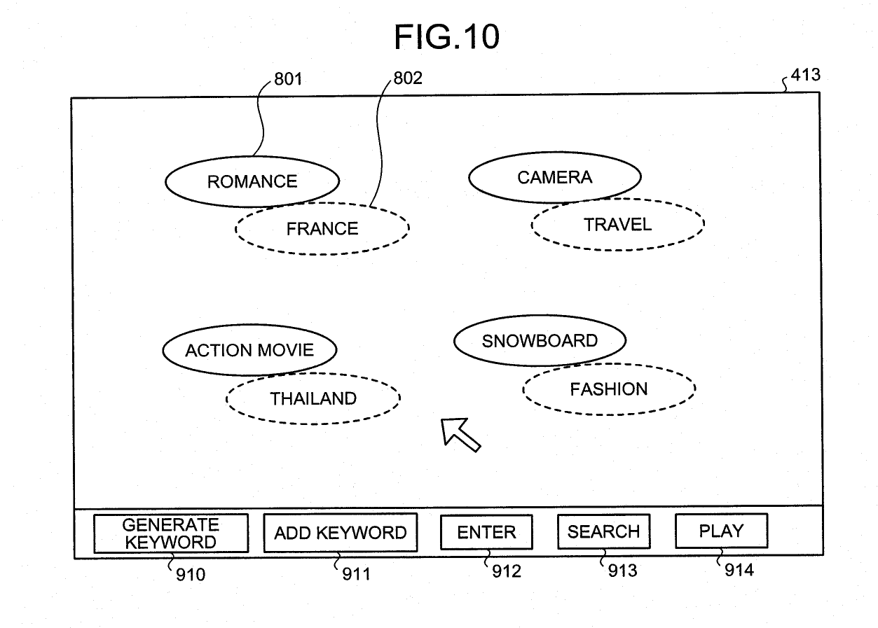

When the display contents depicted in FIG. 9 is displayed on the display 413 and the “generate keyword” button 910 is pressed, combined keywords are displayed. FIG. 10 depicts a display example of combined keywords. As depicted in FIG. 10, for example after a second keyword has been selected at step S506 depicted in FIG. 5, the first keyword and second keyword combination is displayed on the display 413. For example, each of the first keyword 801 and second keyword 802 combinations depicted in FIG. 8 is displayed.

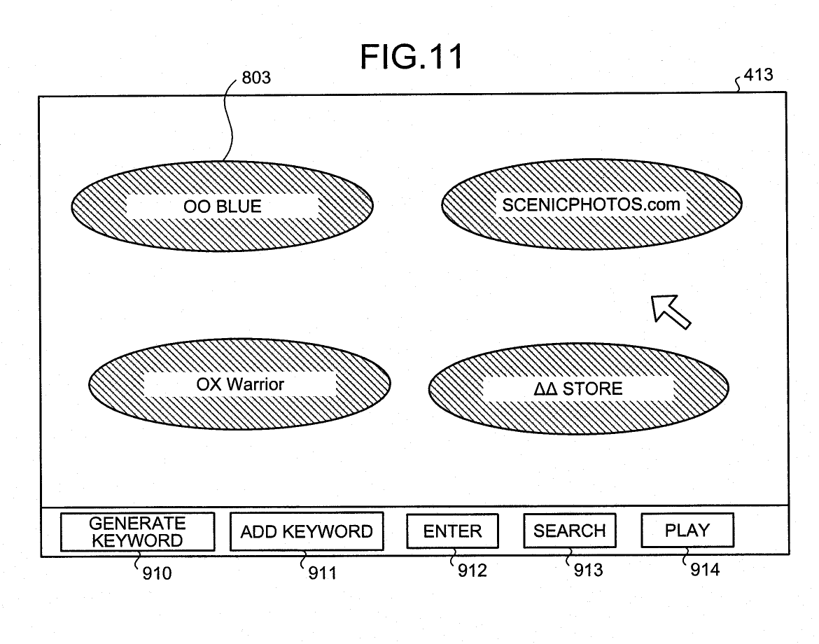

When the display contents depicted in FIG. 10 are displayed on the display 413 and the “enter” button 912 or the “search” button 913 is pressed, information related to content that matches the combined keywords is displayed. FIG. 11 depicts a display example of the information related to content that matches the combined keywords. As depicted in FIG. 11, for example, search results obtained at step S508 depicted in FIG. 5 are displayed on the display 413. For example, the search results 803 depicted in FIG. 8 are displayed.

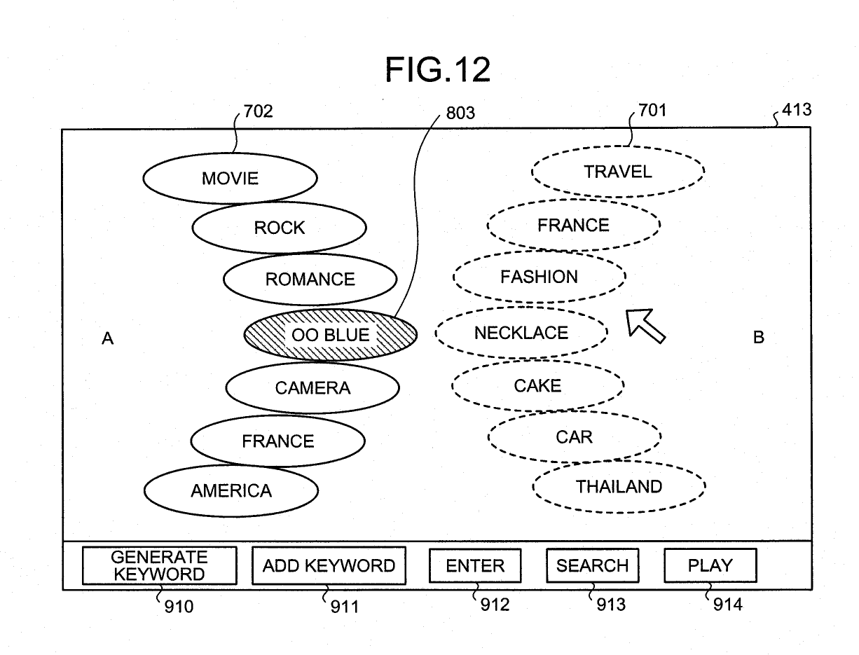

When the display contents depicted in FIG. 11 are displayed on the display 413, if any the content among the search results is designated and the “play” button 914 is pressed, the designated content is played. If the “add keyword” button 911 is pressed, the search results are added to the keywords as a new keyword. FIG. 12 depicts a display example of an added keyword. As depicted in FIG. 12, for example, if a keyword is added at step S512 depicted in FIG. 5, the added keyword is displayed. For example, the search results 803 depicted in FIG. 8 are added to the keywords display depicted in FIG. 9.

As described, according to the navigation apparatus 301 of the example, when the life log data of user A stored in the tag A311 and the life log data of user B stored in the tag B312 are connected, the life log data is transmitted to the keyword generating server 321 and the keywords A702 and the keywords B712 correlated with attribute data and additional information can be acquired. Further, the navigation apparatus 301 of the example enables a first keyword 801 to be selected from among the keywords A702; a second keyword 802 whose attribute information differs from that of the first keyword, to be selected from among the keywords B712; and the residential content server A331 of user A, the residential content server B332 of user B, and the external content server 333 to be searched, via the network 340, for content that matches the first keyword 801 and the second keyword 802.

As a result, user A and user B can retrieve content by keywords that are not generated from the respective life log data or interests/preferences of the users A and B. Consequently, user A and user B are able to expand the range of their respective interests/preferences. Furthermore, odd combinations of keywords can be prevented.

As described, according to the content search apparatus, content search method, content search program, and recording medium of the present invention, content can be retrieved that is along the lines of user interests/preferences and also unpredictable.

The content search method described in the embodiment may be implemented by executing a prepared program on a computer such as a personal computer, a workstation, and a mobile terminal apparatus (mobile telephone). The program is stored on a computer-readable recording medium such as a hard disk, a flexible disk, a CD-ROM, an MO, and a DVD, is read out from the recording medium, and executed by the computer. The program may be distributed through a network such as the Internet.

### EXPLANATIONS OF LETTERS OR NUMERALS

100 content search apparatus
101 authenticating unit
102 history acquiring unit
103 keyword acquiring unit
104 correlating unit
105 determining unit
106 receiving unit
107 combining unit
108 searching unit
109 output unit

1-13. (canceled)

14. A content search apparatus that searches for content matching keywords, the content search apparatus comprising:
a history acquiring unit that acquires a user behavior history;
a keyword acquiring unit that acquires keywords based on the user behavior history acquired by the history acquiring unit;
a correlating unit that correlates with each of the keywords acquired by the keyword acquiring unit, attribute related information;
a combining unit that among the keywords acquired by the keyword acquiring unit, combines the keywords that have been correlated with mutually different attribute related information by the correlating unit; and
a searching unit that searches for content that matches the keywords combined by the combining unit, wherein
the correlating unit correlates with each of the keywords, attribute related information concerning plural attributes, and
the combining unit combines the keywords whose correlated attribute related information overlap least.

15. The content search apparatus according to claim 14, wherein:
the history acquiring unit acquires a plurality of user histories, and
the combining unit combines the keywords that are for different users and that have been correlated with mutually different attribute information.

16. The content search apparatus according to claim 14, further comprising an authenticating unit that authenticates a user, wherein
the history acquiring unit acquires the user behavior history for the user authenticated by the authenticating unit.

17. The content search apparatus according to claim 14, wherein
the correlating unit hierarchizes and correlates with each of the keywords, attribute related information concerning plural attributes, and
the combining unit combines the keywords that, at each hierarchal level, have mutually different correlated attribute related information concerning plural attributes.

18. The content search apparatus according to claim 14, wherein
the correlating unit hierarchizes and correlates with each of the keywords, attribute related information concerning plural attributes, and
the combining unit combines the keywords whose correlated attribute related information concerning plural attributes overlap least at higher hierarchal levels.

19. The content search apparatus according to claim 14, further comprising a determining unit that determines a user behavior trend, based on the user behavior history acquired by the history acquiring unit, wherein
the combining unit combines keywords for which the determining unit has determined the user behavior trend to be identical and that have been correlated with attribute related information that is mutually different.

20. The content search apparatus according to claim 14, further comprising a receiving unit that sequentially receives from a user, two or more of the keywords selected from among the keywords correlated with attribute related information, wherein
the combining unit causes the user to select another keyword whose correlated attribute related information is different from that of a keyword initially received by the receiving unit, and combines the keyword initially received and the other keyword selected by the user.

21. The content search apparatus according to claim 14, further comprising an output unit that outputs a search result obtained by the searching unit.

22. The content search apparatus according to claim 14, wherein
the keyword acquiring unit acquires, as a new keyword, a search result obtained by the searching unit.

23. A content search method of a content search apparatus that searches for content matching keywords, the content search method comprising:
acquiring a user behavior history;
acquiring keywords based on the acquired user behavior history;
correlating with each of the acquired keywords, attribute related information;
combining among the acquired keywords, the keywords that have been correlated with mutually different attribute related information; and
searching for content that matches the combined keywords, wherein
the correlating includes correlating with each of the keywords, attribute related information concerning plural attributes, and
the combining includes combining the keywords whose correlated attribute related information overlap least.

24. A non-transitory, computer-readable recording medium storing therein a content search program that causes a computer to execute:
acquiring a user behavior history;
acquiring keywords based on the acquired user behavior history;
correlating with each of the acquired keywords, attribute related information;
combining among the acquired keywords, the keywords that have been correlated with mutually different attribute related information; and
searching for content that matches the combined keywords, wherein
the correlating includes correlating with each of the keywords, attribute related information concerning plural attributes, and
the combining includes combining the keywords whose correlated attribute related information overlap least.
